(19) United States
(12) Patent Application Publication
(10) Pub. No.: US 2007/0239568 A1
(43) Pub. Date: Oct. 11, 2007

(54) Data Collection, Manipulation, Reconciliation, and Reporting for Multiple Sites

(75) Inventors: William S. Conley, Irving, TX (US); Thomas B. Oxendine, Denton, TX (US)

Correspondence Address: FULBRIGHT & JAWORSKI L.L.P., 600 CONGRESS AVE., SUITE 2400, AUSTIN, TX, 78701, US

(73) Assignee: QT TECHNOLOGIES, LLC

(21) Appl. No.: 11/691,329

(22) Filed: Mar. 26, 2007

Related U.S. Application Data
(60) Provisional application No. 60/785,717, filed on Mar. 24, 2006.

(51) Int. Cl. G06Q 10/00

(52) U.S. Cl. 705/28

(57) ABSTRACT

Methods and systems for determining a real-time or near-real time reconciliation list are disclosed. One or more datasets of inventory and financial transactions may be received from different locations of an enterprise or as a result of a payment processing function of the system. The data may combined, manipulated, and reconciled, thereby providing an accurate inventory list and payments processed.

This application claims priority to provisional patent application Ser. No. 60/785,717 filed Mar. 24, 2006. The entire text of each of the above-referenced disclosure, including figures, is specifically incorporated by reference herein without disclaimer.

### BACKGROUND OF THE INVENTION

1. Field of the Invention

The present invention relates generally to processing of data. More particularly, the present invention uses multiple data sets to determine real-time inventory status across an enterprise.

2. Description of Related Art

Many businesses are not aware of the metrics of their enterprise at any given time. Tracking inventory loss due to theft, breakage, or leaks, as well as impacts on the environment is difficult to do in a multiple site enterprise. Therefore, businesses are in need of real-time or near real-time enterprise wide reporting. This need may require the ability to reconcile inventory, product sales, and transactions on a real-time or near real-time basis. This information can be critically important for making real-time purchasing decisions of commodities whose prices fluctuate on a regular basis.

Current techniques for determining inventory data generally require determining what was sold over a certain period and taking the difference between an inventory list at the beginning of that period. However, current techniques fail to take consideration of other important statistics including, but not limited to, damaged products, stolen products, defective products, and the like. As such, the accuracy of the inventory list, especially a global view of a company's inventory, can be inaccurate.

For example, the current “Custody Transfer” market is highly fragmented and, therefore, making real-time or near real-time reconciliation difficult, if not impossible without large and complex internal software systems. It is speculated that even with such systems, end data collection devices are not logically connected to the system, making real-time reconciliation impossible.

Another common problem with current point-of-sale systems is that the payment processing protocols change constantly from the credit and debit card companies. This requires software or firmware updates to thousands of units in the field each time these protocols change.

Any shortcoming mentioned above is not intended to be exhaustive, but rather is among many that tend to impair the effectiveness of previously known techniques for real-time or near real-time reconciliation of an inventory list; however, shortcomings mentioned here are sufficient to demonstrate that the methodologies appearing in the art have not been satisfactory and that a significant need exists for the techniques described and claimed in this disclosure.

### SUMMARY OF THE INVENTION

The present disclosure provides reconciliation techniques that can generate a real-time or near real-time inventory list of an enterprise by utilizing a plurality of data sets. In particular, the present disclosure provides manipulating payment information, inventory levels, and inventory transactions data to generate an accurate list for a company global-wide.

In one respect, the present disclosure provides a centralized repository, transaction, and reporting system to handle both point-of-sale (“POS”) transactions and reconciliation of inventory versus sales. A datacenter is also provided to interface with a set of credit card companies using workflow like tools to define, configure, and maintain protocols. A standard and customizable set of reports and applications may be provided. The reports and applications, which may be obtained via web-based or other connection mediums (e.g., wired or wireless) may allow customers to view data in the datacenter as well as configure their systems. A standard interface into the datacenter may be provided to allow any or most POS systems to use the datacenter for their credit card transaction processing

The basic mobile hardware and software include features such as credit card transactions capabilities, credit card reader support, cellular, and satellite or other wireless communication channels. A base design may include standard hardware/software platform supporting both stationary and mobile terminal requirements as well as other transaction-based control devices. The terminals may include standard operating system software and drivers readily available. The mobile hardware may be similar or may have the same basic architecture as stationary systems but supporting standard vehicle power and peripherals suitable for mobile applications.

The present disclosure also provides software communication drivers for standard handheld devices to support data center credit card transactions and provide for control and monitoring support of the various handheld devices. Communication drivers may be provided for standard telemetry devices to support the datacenter and to provide for control and monitoring support of various devices (tank monitors, security access, etc.).

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The figures are examples only. They do not limit the scope of the invention.

FIG. 1 is a system diagram, in accordance with embodiments of the present disclosure.

FIG. 2 is a flowchart depicting a method, in accordance with embodiments of the present disclosure.

### DESCRIPTION OF ILLUSTRATIVE EMBODIMENTS

This disclosure and the various features and advantageous details of its subject matter are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those or ordinary skill in the art from this disclosure.

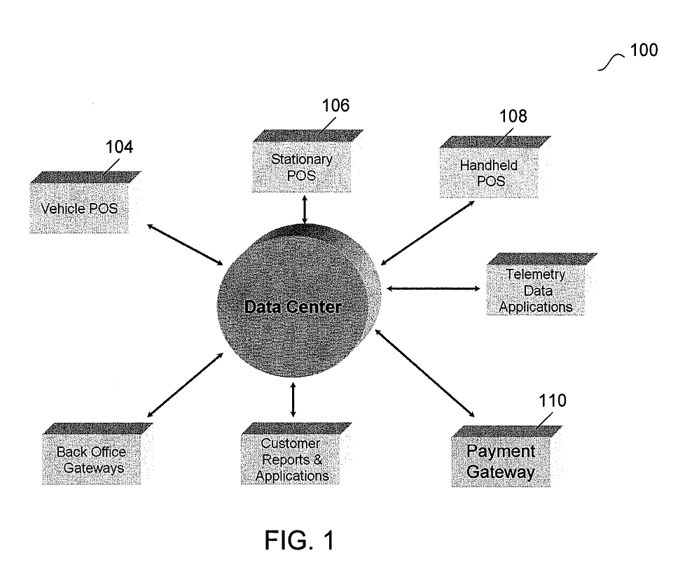

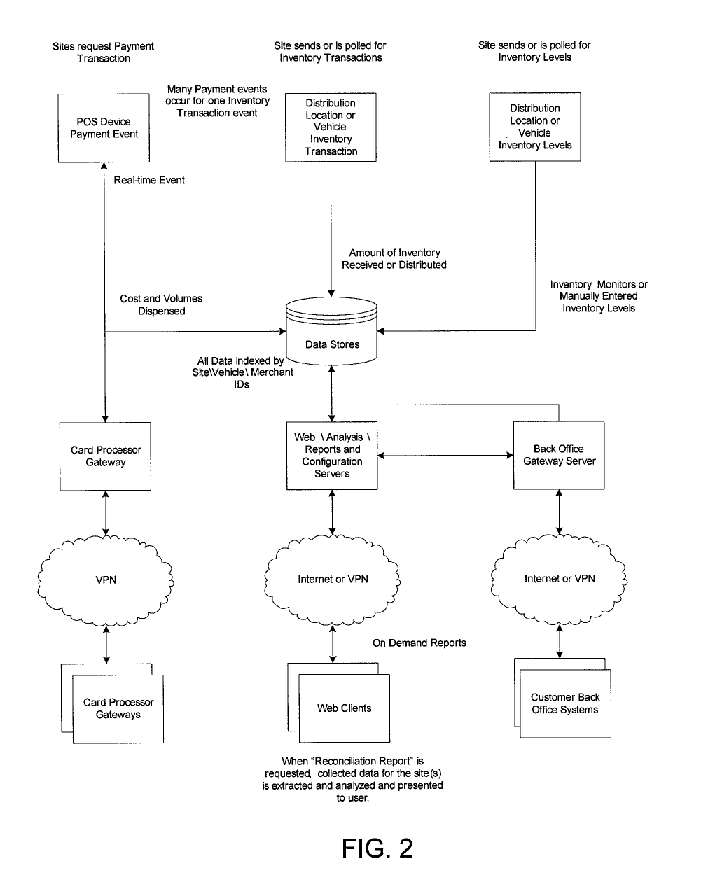

In one respect, the present disclosure provides a system located at a remote datacenter and configured to receive one or more datasets from one or more locations (e.g., storefronts, mobile storefronts, mobile delivery units, etc.). The information and data can be downloaded or transferred over a wired or wireless network. Alternatively, the data may be manually entered. The datasets may include, without limitation, payment information, inventory levels, and/or inventory transactions. In one respect, the system may provide gateways to a wide variety of data collection devices (e.g., mobile point-of-sale (POS) device, handheld device, stationary POS) at the one or more collection sites, as shown in FIGS. 1 and 2. Using the received datasets, from, for example, vehicle POS 104, stationary POS 106, handheld POS 108, the system may provide a multi-dimensional reconciliation using three or more of the data sources to reconcile transactions, payments, and inventory. In one respect, the system may also schedule or provide real-time reporting on a single site, a defined set of sites, or at an enterprise level. Data from the POS may be automatically transmitted to the data center, sent at a set interval, or may be sent on-demand.

Additionally, the system may provide gateways to a variety of payment processors and bank networks for payment processing. The gateways may provide a single point for protocol updates, thereby eliminating the need for continuous updates to thousands of sites. Referring to FIG. 1, payment gateway 110 may be coupled to data center 102. The system accordingly allows one to determine the least-cost-routing of credit cards, debit cards, private card, smart card, and contact-less credit card transactions via payment gateway 110.

In one respect, system 100 may include communication drivers for standard telemetry devices to support the datacenter and to provide for control and monitoring support of various devices (tank monitors, security access, etc.). Telemetry devices 112 may be coupled to datacenter via any communication channels including, but not limited to, wired or wireless communications.

In one respect, a single protocol may be loaded via, for example, an array or redundant modems and/or POT lines, to some or all the terminals to eliminate or substantially reduce maintenance issues related to protocol alterations by process. The single protocol may be a serial-based protocol, which provides security and message integrity. The single protocol may also include potential field needed to process transactions, thus reducing talk-back communications between the terminals and/or the datacenter.

A serial protocol manager may be used to translate the serial messages received by the terminals into XML messages. XML messages may be easier to manage and are native to web service calls. In one respect, the XML messages may be encrypted using, for example, industry standard encryption algorithm such as, but not limited to Triple DES. The encryption allows for internal transaction messages to be secure even in the event that the front line network is compromised.

In alternative or additional embodiments, the system may allow a single-click changing of configuration information for one or more specified locations. This may allow change of inventory prices or schedule software updates. Furthermore, the system may provide real-time alerts concerning failures or problems in the field due to hardware or software. Therefore, down-time at individual sites may be minimal.

In other embodiments, the system may provide gateways to allow data exchange between other systems for reporting and accounting functions. For example, system 100 may include back office gateway 114. Via a secure internet protocol or other secure networking channels, information including for example inventory from various POS, may be provided to a back office software package. The information may be used for accounting purposes and other business transactions and reports. The data transferred may also be stored as backup for a predetermined amount of time by the back office software’ server. In some embodiments, the information may be reformatted at the Client or the Data Center or a combination of both to confirm with data formats of the back office software package.

In addition to any combination of the above components or alternatively, system 100 may provide a gateway for customer configuration (e.g., a consumer of the enterprise). A configuration manager may provide customers customization efforts including, for example, report formats, delivery methods, delivery times for the report, processor settings (e.g., banking information), terminal settings, and the like.

In one respect, a customer reports and application gateway 116, coupled to data center 102, may provide an interface to a client over, for example, the Internet. The interface may be a GUI, a webpage, a FTP site or other interfaces known in the art. In one respect, the customer report may provide financial and/or volume metric (e.g., inventory data).

A reporting manager may be employed to provide reporting services to customers. In one respect, the reporting may be a web-based transaction reporting. In addition or alternatively, the reports may be a static business report that may be used for files in accounting programs known in the art. For example, the report may include data related to leaks or thefts (e.g., for a liquid commodity, tank levels compared with delivery history), usage or sales forecast for automatic ordering, tracking of shipping or delivery trucks using, for example, a GPS system, system configuration (e.g., functionalities of the terminals), summary reports showing credit card, bank card, and/or cash intake, and/or customer, sales, and inventory reports.

The system components, shown for example, in FIG. 1 may be or include service-based software components that may be set up for automated processing (e.g., automated data downloading, automated component recover, etc.). Furthermore, the centralized operations may allow the system to be optimize for remote operations and administrations, which may reduce support and component costs.

The system shown in FIGS. 1 and 2 may employ a transaction manager to maintain and enforce transaction rules throughout the system. The transaction manager may restrict access to the system, control the type of payment instruments, verify for valid account numbers, confirm that a client is not in collections or credit hold, or any combination of the above. In one respect, the transaction manager may be a flexible rules-based engine that may allow for new requirements to be included into the process easily.

The system may also employ a variety of other software managers including, for example, processor protocol manager for handling data exchange with credit card processing service companies. In addition or alternatively, the system may include a reconciliation manager for auditing and reconciling inventory and financial transaction at a POS level and/or an enterprise level. The reconciliation and auditing process may be organized by a logging manager which may create and organize these and other tasks of the system.

Referring to Tables 1 through 3, examples of data and data formats received by the datacenter are shown. One basic concept concerning the datacenter is to have a client system (e.g., POS system) as thin as possible. Therefore, entire card processing can be offloaded to the datacenter. The client system may collect the card information, encrypt, and send the information to the data center for processing. Subsequently, the datacenter may return status codes (e.g., approved, reject, etc.).

TABLE 1
Track 1 Data Format

| Field Name | Track Data Description | Length |
|---|---|---|
| | Start sentinel | 1 |
| | Format code (alpha only) | 1 |
| AccountNumber | Primary account number | Up to 19 characters |
| | Separator | 1 |
| CountryCode | Country code | 3 |
| Name | Name | 2-26 characters |
| | Separator | 1 |
| ExpDate | Expiration date (separator | 4 characters or |
| | used if exp date omitted) | 1 character |
| AdditionalTrack1Data | Discretionary data | Sufficient pad |
| | | characters to |
| | | complete maximum |
| | | record length |
| | | (79 characters) |
| | End sentinel | 1 |
| | Longitudinal Redundancy | 1 |
| | Check (LRC) | |

TABLE 2
Track 2 Data Format

| Field Name | Track Data Description | Length |
|---|---|---|
| | Start sentinel | 1 |
| AccountNumber | Primary account number | Up to 19 characters |
| | Separator | 1 |
| CountryCode | Country code | 3 |
| ExpDate | Expiration date (separator | 4 characters or 1 |
| | used if exp date omitted) | character |
| AdditionalTrack2Data | Discretionary data | Sufficient pad |
| | | characters to |
| | | complete maximum |
| | | record length |
| | | (40 characters) |
| | LRC | 1 |

TABLE 3
Transaction Response Fields

| Field Name | Track Data Description | Length |
|---|---|---|
| ResponseCode | The coded response of the | Variable |
| | transaction processing | |
| | request | |
| ResponseCodeDescription | The human readable | Variable |
| | description of the | |
| | ResponseCode | |
| AuthCode | The authorization code | Variable |
| | provided by the third party | |
| | processor or originating | |
| | financial institution. | |
| AVSResponseCode | The coded response | Variable |
| | denoting the result of the | |
| | AVS comparison | |
| CIDResponseCode | The coded response | Variable |
| | denoting the result of the | |
| | CID comparison | |
| TransactionId | The transaction identifier | Variable |
| | assigned by the QT data | |
| | center | |
| TransactionHash | A one-way hash value | Variable |
| | uniquely identifying the | |
| | transaction, used to | |
| | authenticate the transaction | |
| | for subsequent operations | |
| | (reserved for future use) | |

Techniques of this disclosure, including, for example, the multiple managers employed by the system, may be accomplished using any of a number of programming languages. For example, the techniques of the present disclosure may be performed on a computer readable medium. Suitable languages include, but are not limited to, BASIC, FORTRAN, PASCAL, C, C++, C#, JAVA, HTML, XML, PERL, etc. An application configured to carry out the invention may be a stand-alone application, network based, or wired or wireless Internet based to allow easy, remote access. The application may be run on a personal computer, a data input system, a point of sale device, a PDA, cell phone or any computing mechanism.

Computer code for implementing all or parts of this disclosure may be housed on any processor capable of reading such code as known in the art. For example, it may be housed on a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc. The computer code may be executable on any processor, e.g., any computing device capable of executing instructions according to the methods of the present disclosure. In one embodiment, the processor is a personal computer (e.g., a desktop or laptop computer operated by a user). In another embodiment, processor may be a personal digital assistant (PDA), a gaming console, a gaming device, a cellular phone, or other handheld computing device.

In some embodiments, the processor may be a networked device and may constitute a terminal device running software from a remote server, wired or wirelessly. Input from a source or other system components may be gathered through one or more known techniques such as a keyboard and/or mouse, and particularly may be received form image device, including but not limited to a camera and/or video camera. Output, such as the image mosaic may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The processor may use any type of monitor or screen known in the art, for displaying information. For example, a cathode ray tube (CRT) or liquid crystal display (LCD) can be used. One or more display panels may also constitute a display. In other embodiments, a traditional display may not be required, and the processor may operate through appropriate voice and/or key commands.

All of the methods disclosed and claimed can be made and executed without undue experimentation in light of the present disclosure. While the methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the disclosure as defined by the appended claims.

1. A method comprising:
receiving payment information;
receiving inventory data;
receiving inventory transaction data;
determining inventory loss based on the inventory data and inventory transaction data; and
determining an inventory list using the payment information, inventory data, inventory transaction data, and the inventory loss.

2. The method of claim 1, where receiving payment information, inventory data, and inventory transaction data comprise receiving such information and data from a plurality of data devices.

3. The method of claim 1, further comprising processing the payment information.

4. The method of claim 1, further comprising reporting the inventory list at substantially real-time.

5. The method of claim 1, receiving payment information, inventory data, and inventory transaction data comprises receiving data from a storefront, a mobile storefront, or a delivery unit.

6. The method of claim 1, receiving payment information, inventory data, and inventory transaction data comprises receiving data from an enterprise.

7. The method of claim 1, where determining inventory loss comprises determining the difference between the inventory data and the inventory transaction data.

8. The method of claim 1, where determining inventory loss further comprises determining inventory lost due to theft.

9. The method of claim 1, where determining inventory loss further comprises determining inventory lost due to leakage.

10. A method comprising:
receiving payment information from a plurality of point-of-sale devices, the plurality of point-of-sale devices are part of a business enterprise;
receiving inventory data from the plurality of point-of-sale devices;
receiving inventory transaction data from the plurality of point-of-sale devices; and
determining an inventory list using the payment information, inventory data, and inventory transaction data.

11. The method of claim 10, where receiving payment information the plurality of point-of-sale devices comprises receiving payment information from a mobile unit, a mobile storefront, a storefront, or a combination thereof.

12. The method of claim 10, where determining an inventory list comprises determining a lost inventory due to theft.

13. The method of claim 10, where determining an inventory list comprises determining a lost inventory due to leakage.

14. The method of claim 10, the step of determining an inventory is at substantially real-time.
